(19) United States
(12) Patent Application Publication
(10) Pub. No.: US 2018/0057198 A1
(43) Pub. Date: Mar. 1, 2018

(54) PRODUCT DETECTION SYSTEM

(71) Applicant: Robert Bosch GmbH, Stuttgart (DE)

(72) Inventors: Stephen Anderson, New Richmond, WI (US); John Schmidt, Bloomer, WI (US); John Konitzer, Cottage Grove, MN (US)

(21) Appl. No.: 15/245,721

(22) Filed: Aug. 24, 2016

(51) Int. Cl. B65B 57/04; B65B 51/30; B65B 57/10; B29C 65/00

(52) U.S. Cl. CPC B65B 57/04; B65B 51/30; B29C 66/90; B29C 66/849; B29C 66/872; B65B 57/10

(57) ABSTRACT

A product detection system includes a first frame piece configured to be coupled to a first sealing jaw of a sealing machine, a second frame piece configured to be coupled to a second sealing jaw of the sealing machine, a first detector bar slidably coupled to the first frame piece, a second detector bar slidably coupled to the second frame piece, a first linear actuator coupled to the first detector bar to move the first detector bar, and a second linear actuator coupled to the second detector bar to move the second detector bar. An encoder is coupled to the second detector bar to detect movement of the second detector bar. The first and second linear actuators are configured to move the first and second detector bars toward one another.

### BACKGROUND

The present invention relates to a system for detecting a product and preventing damage to the product in a manufacturing setting.

A sealing machine in a manufacturing setting commonly includes a pair of sealing jaws that move toward and away from products being packaged in plastic bags or other packaging, to seal ends of the packaging together before the packaged products are moved to another area of the facility. However, the products may sometimes become misaligned as they approach the sealing jaws, thereby resulting in damage to the product when the jaws attempt to seal the product packaging.

### SUMMARY

In accordance with one construction, a product detection system includes a first frame piece configured to be coupled to a first sealing jaw of a sealing machine, a second frame piece configured to be coupled to a second sealing jaw of the sealing machine, a first detector bar slidably coupled to the first frame piece, a second detector bar slidably coupled to the second frame piece, a first linear actuator coupled to the first detector bar to move the first detector bar, and a second linear actuator coupled to the second detector bar to move the second detector bar. An encoder is coupled to the second detector bar to detect movement of the second detector bar. The first and second linear actuators are configured to move the first and second detector bars toward one another.

In accordance with another construction, a system includes a sealing machine having a first sealing jaw and a second sealing jaw. The first and second sealing jaws are movable toward one another. The system also includes a product detection system coupled to the sealing machine to detect a portion of a misaligned product. The product detection system includes a first detector bar and a second detector bar that move toward one another and toward the portion of the misaligned product.

In accordance with another construction, a method of detecting a portion of a misaligned product includes directing a first detector bar and a second detector bar toward one another with a first linear actuator and a second linear actuator, respectively. The second linear actuator exerts a lower force relative to the first linear actuator. The method further includes directing a first sealing jaw and a second sealing jaw toward one another, contacting a portion of a misaligned product with the first and second detector bars, reversing a direction of movement of the second detector bar upon contact of the portion of the misaligned product, detecting the reversed movement of the second detector bar with the a linear encoder, and stopping movement of the first sealing jaw and the second sealing jaw toward one another upon detection of the reversed movement.

Other independent aspects of the invention will become apparent by consideration of the detailed description and accompanying drawings.

### BRIEF DESCRIPTION OF THE DRAWINGS

FIG. 1 is a top perspective view of a product detection system according to one construction.

FIG. 2 is a perspective view of controls for the product detection system.

FIG. 3 is a bottom perspective view of the product detection system.

FIG. 4 is a side view of the product detection system coupled to a bottom of a sealing machine, the product detection system in a fully opened state.

FIG. 5 is a side view of the product detection system and the sealing machine, the product detection system being in a closing state.

FIG. 6 is a side view of the product detection system and the sealing machine, the product detection system being in a fully closed state.

FIG. 7 is a side view of the product detection system and the sealing machine, the product detection system being in an opening state.

FIG. 8 is a side view of the product detection system coupled to a bottom of a sealing machine, the product detection system in a fully opened state.

FIG. 9 is a side view of the product detection system and the sealing machine, the product detection system being in a closing state.

FIG. 10 is a side view of the product detection system and the sealing machine, the product detection system having detected a portion of a misaligned product.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

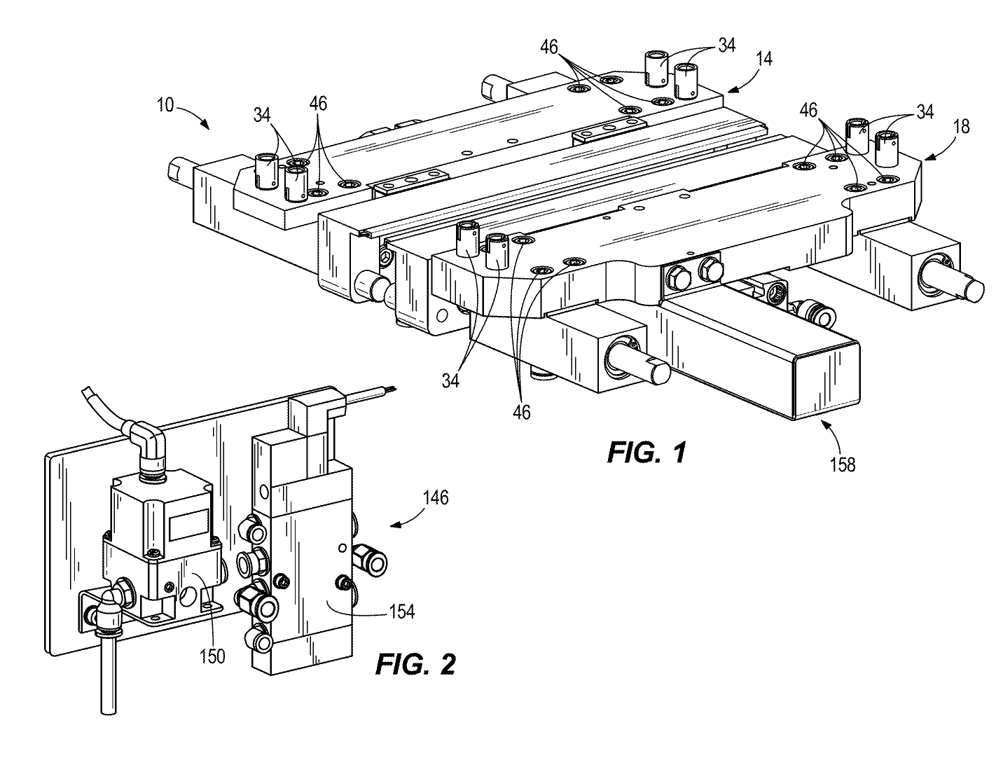

FIGS. 1-10 illustrate a product detection system 10. The product detection system 10 is described in the context of a manufacturing setting (e.g., a manufacturing plant), and for use with a sealing machine in the manufacturing setting. However, the product detection system 10 may be used in various other settings, and with various other machines other than sealing machines, to detect a portion of a misaligned product, and to prevent damage to the product.

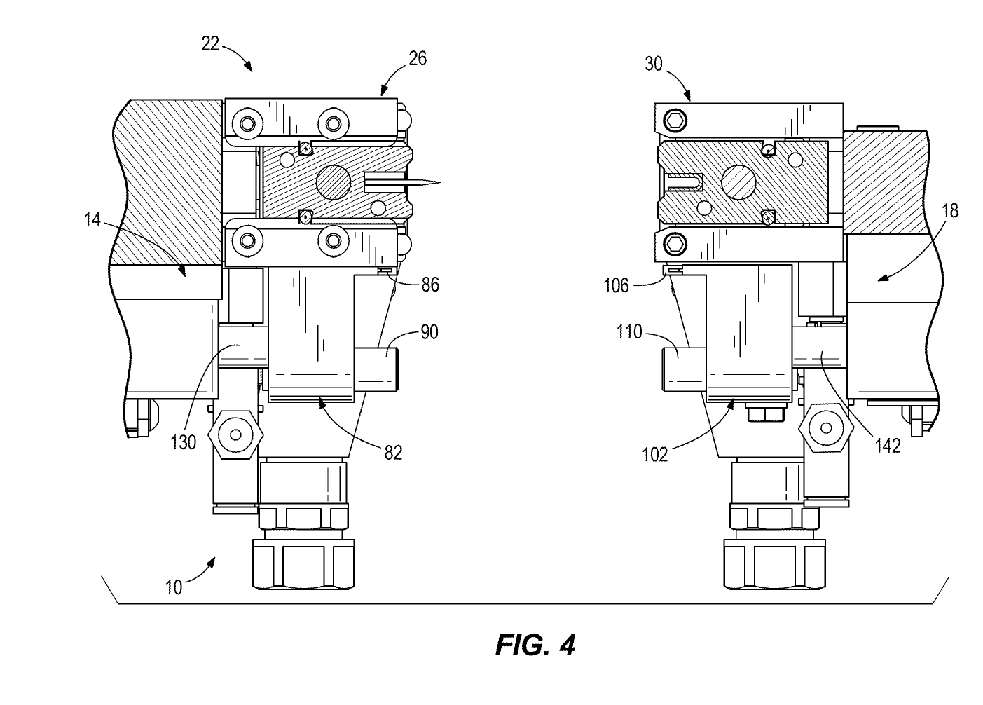

With reference to FIGS. 1-10, the product detection system 10 includes a first frame piece 14 and a second frame piece 18 that are each coupled to a sealing machine 22 (FIGS. 4-10). As illustrated in FIGS. 4-10, the sealing machine 22 includes a first sealing jaw 26 and a second sealing jaw 30. The first frame piece 14 is coupled to the first sealing jaw 26, and the second frame piece 18 is coupled to the second sealing jaw 30. As illustrated in FIG. 1, the first frame piece 14 and the second frame piece 18 each include one or more mounting features 34 (e.g., threaded apertures, bosses, etc.) that fixedly couple the first frame piece 14 to the first sealing jaw 26 and the second frame piece 18 to the second sealing jaw 30, such that the first frame piece 14 moves with the first sealing jaw 26 and the second frame piece 18 moves with the second sealing jaw 30. In some constructions the first frame piece 14 is integrally coupled (i.e., formed as single piece) with the first sealing jaw 26, and the second frame piece 18 is integrally coupled with the second sealing jaw 30.

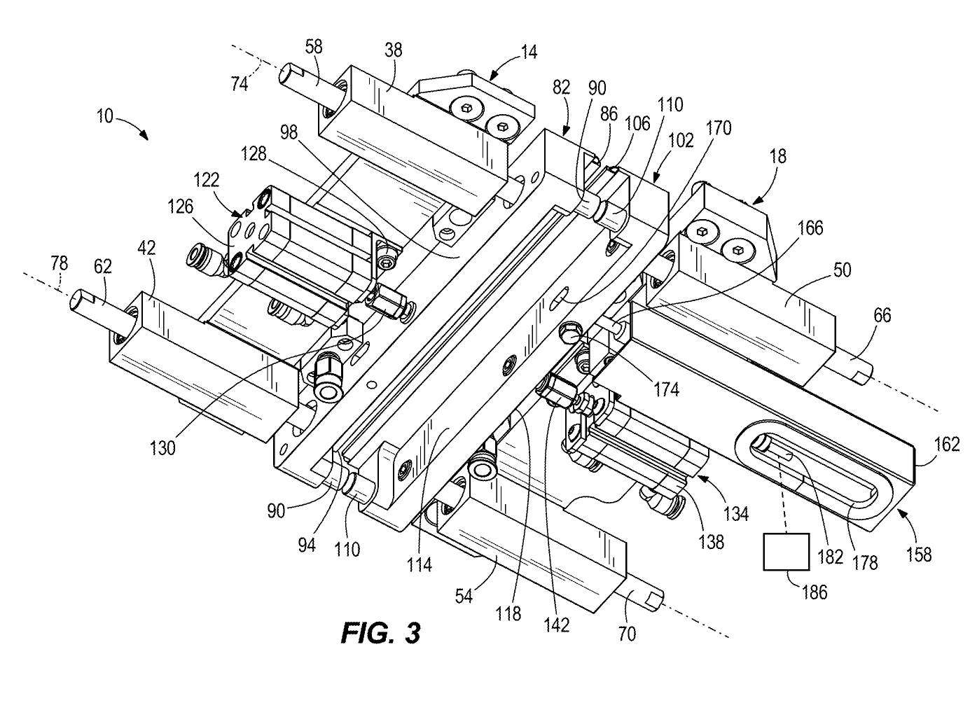

With reference to FIG. 3, the product detection system 10 further includes a first linear bearing 38 and a second linear bearing 42 that are each coupled to the first frame piece 14. In the illustrated construction the first linear bearing 38 and the second linear bearing 42 are fixed to the first frame piece 14 with fasteners 46 (FIG. 1). In other constructions the first linear bearing 38 and the second linear bearing 42 are integrally coupled with the first frame piece 14. The product detection system 10 further includes a third linear bearing 50 and a fourth linear bearing 54 that are each coupled to the second frame piece 18. In the illustrated construction the third linear bearing 50 and the fourth linear bearing 54 are fixed to the second frame piece 18 with fasteners 46 (FIG. 1). In other constructions the third linear bearing 50 and the fourth linear bearing 54 are integrally coupled with the second frame piece 18. Other constructions include different numbers and arrangements of linear bearings than that illustrated. For example, in some constructions the product detection system 10 includes only a single linear bearing coupled to the first frame piece 14 and only a single linear bearing coupled to the second frame piece 18.

With continued reference to FIG. 3, the product detection system 10 further includes a first slide rail 58 that extends through the first linear bearing 38, a second slide rail 62 that extends through the second linear bearing 42, a third slide rail 66 that extends through the third linear bearing 50, and a fourth slide rail 70 that extends through the fourth linear bearing 54. The first slide rail 58 extends parallel to the second slide rail 62, and the third slide rail 66 extends parallel to the fourth slide rail 70. The first slide rail 58 is aligned along a first common axis 74 with the third slide rail 66, and the second slide rail 62 is aligned along a second common axis 78 with the fourth slide rail 70. The first common axis 74 is parallel to the second common axis 78. Other constructions include different numbers and/or arrangement of slide rails than that illustrated. For example, in some constructions the product detection system 10 includes a single slide rail coupled to a single linear bearing on the first frame piece 14 and a single slide rail coupled to a single linear bearing on the second frame piece 18.

With continued reference to FIG. 3, the product detection system 10 further includes a first detector bar 82. The first detector bar 82 is coupled (e.g., fixed) to ends of both the first slide rail 58 and the second slide rail 62. In the illustrated construction the first detector bar 82 is elongate and generally rectangular, although other constructions include different shapes than that illustrated. The first detector bar 82 includes at least one first bumper 86 and at least one first stopper 90. In the illustrated construction the first detector bar 82 includes a single first bumper 86 that is a thin elongate rubber structure that extends generally perpendicularly from a first side 94 of the first detector bar 82. In the illustrated construction the first detector bar 82 includes two first stoppers 90 that are each cylindrical metal structures that extend generally perpendicularly from the first side 94 of the first detector bar 82. The two first stoppers 90 are located on opposite ends of the first detector bar 82, although other constructions include different locations for the first stoppers 90, as well as different materials and shapes than that illustrated. As illustrated in FIG. 3, the first detector bar 82 further includes a second side 98 opposite the first side 94. In the illustrated construction the first slide rail 58 and the second slide rail 62 are coupled to the first detector bar 82 on the second side 98.

With continued reference to FIG. 3, the product detection system 10 further includes a second detector bar 102. The second detector bar 102 is coupled (e.g., fixed) to ends of both the third slide rail 66 and the fourth slide rail 70. In the illustrated construction the second detector bar 102 is elongate and generally rectangular, although other constructions include different shapes than that illustrated. The second detector bar 102 includes at least one second bumper 106 and at least one second stopper 110. In the illustrated construction the second detector bar 102 includes a single second bumper 106 that is a thin elongate rubber structure that extends generally perpendicularly from a first side 114 of the second detector bar 102. In the illustrated construction the second detector bar 102 includes two second stoppers 110 that are each cylindrical metal structures that extend generally perpendicularly from the first side 114 of the second detector bar 102. The two second stoppers 110 are located on opposite ends of the second detector bar 102, although other constructions include different locations for the second stoppers 110, as well as different materials and shapes than that illustrated. As illustrated in FIG. 3, the second detector bar 102 further includes a second side 118 opposite the first side 114. In the illustrated construction the third slide rail 66 and the fourth slide rail 70 are coupled to the second detector bar 102 on the second side 118.

With continued reference to FIG. 3, the first side 94 of the first detector bar 82 faces the first side 114 of the second detector bar 102. The first bumper 86 of the first detector bar 82 is aligned with and directly faces the second bumper 106 of the second detector bar 102, and the first stoppers 90 of the first detector bar 82 are aligned with and directly face the second stoppers 110 of the second detector bar 102. As illustrated in FIGS. 4-10, when the product detection system 10 is coupled to the sealing machine 22 the first detector bar 82 is positioned below and adjacent the first sealing jaw 26, and the second detector bar 102 is positioned below and adjacent the second sealing jaw 30.

In the illustrated construction the product detection system 10 is oriented generally horizontally, such that the first detector bar 82 and the second detector bar 102 travel horizontally underneath the first sealing jaw 26 and the second sealing jaw 30. However, in other constructions the product detection system 10 may be oriented vertically, or at any other angle.

With continued reference to FIG. 3, the product detection system 10 further includes a first linear actuator 122. The first linear actuator 122 is coupled to the first detector bar 82, to generate linear movement of the first detector bar 82 along the common axes 74, 78 when activated. In the illustrated construction the first linear actuator 122 is an air cylinder that includes a first housing 126 that is fixed via at least one fastener 128 to the first frame piece 14, and a first moving member 130 (e.g., a rod) that is coupled to both the housing 126 and the first detector bar 82. When the first linear actuator 122 is actuated, the first detector bar 82 is driven linearly relative to the first frame piece 14 along the common axes 74, 78. Other constructions include different types of actuators than a pneumatic first linear actuator 122. For example, in some constructions the first linear actuator 122 is a hydraulic actuator, or a servo driven linear actuator.

With continued reference to FIG. 3, the product detection system 10 further includes a second linear actuator 134. The second linear actuator 134 is coupled to the second detector bar 102, to generate linear movement of the second detector bar 102 along the common axes 74, 78 when activated. In the illustrated construction the second linear actuator 134 is an air cylinder that includes a second housing 138 that is fixed via at least one fastener (not shown) to the second frame piece 18, and a second moving member 142 (e.g., a rod) that is coupled to both the second housing 138 and the second detector bar 102. When the second linear actuator 134 is actuated, the second detector bar 102 is driven linearly relative to the second frame piece 18 along the common axes 74, 78, in a direction opposite to the first detector bar 82. Other constructions include different types of actuators than a pneumatic second linear actuator 134. For example, in some constructions the second linear actuator 134 is a hydraulic actuator, or a servo driven linear actuator.

With reference to FIG. 2, the product detection system 10 further includes a control module 146 that controls forces and/or pressures in the first linear actuator 122 and the second linear actuator 134. In the illustrated construction the control module 146 includes a low pressure variable regulator 150 and a switch valve 154, although other constructions include different regulators and/or valves.

With reference to FIG. 3, the product detection system 10 further includes an encoder 158 coupled to the second detector bar 102. In the illustrated construction the encoder is a linear encoder. The linear encoder 158 includes a main housing 162. In some constructions the main housing 162 is coupled to (e.g., fixed) the second frame piece 18. In other constructions the main housing 162 is fixed to another structure. The linear encoder 158 further includes a shaft 166 that extends from the main housing 162 and is movable linearly relative to the main housing 162. As illustrated in FIG. 3, the second detector bar 102 includes a slot 170 that receives an end of the shaft 166. A fastener (e.g., bolt) 174 passes into the slot 170 and secures the end of the shaft 166 within the slot 170.

With continued reference to FIG. 3, the main housing 162 includes an aperture 178 along a bottom of the main housing 162. A cable 182 is positioned within the main housing 162 and is exposed and accessible through the aperture 178. The cable 182 is coupled to a controller 186 (illustrated schematically). In some constructions the controller 186 is a computer. The linear encoder 158 measures displacement of the shaft 166 relative to the main housing 162. In some constructions the controller 186 includes software that calculates and/or displays displacements of the shaft 166, based on one or more signals from the linear encoder 158. In some constructions the controller 186 (or a different controller) controls the control module 146, and/or the forces and/or pressures in the first linear actuator 122 and the second linear actuator 134.

FIGS. 4-7 illustrate a normal, or default, sequence of operations of the product detection system 10 and the sealing machine 22, when no products are mis-aligned as the products pass through the sealing machine 22.

With reference to FIG. 4, the first detector bar 82 and the second detector bar 102 are initially fully retracted away from one another. The first sealing jaw 26 and the second sealing jaw 30 are also initially fully retracted away from one another.

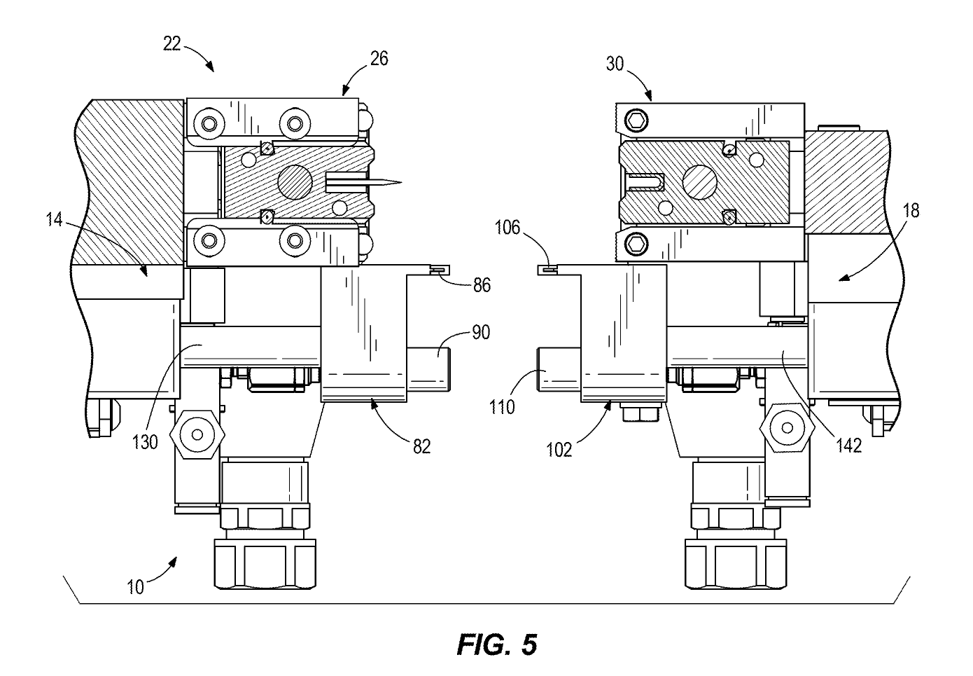

With reference to FIG. 5, the first sealing jaw 26 and the second sealing jaw 30 remain fully retracted away from one another while the first detector bar 82 and the second detector bar 102 begin to move toward one another, due to activation of (e.g., changing pressure within) the first linear actuator 122 and the second linear actuator 134.

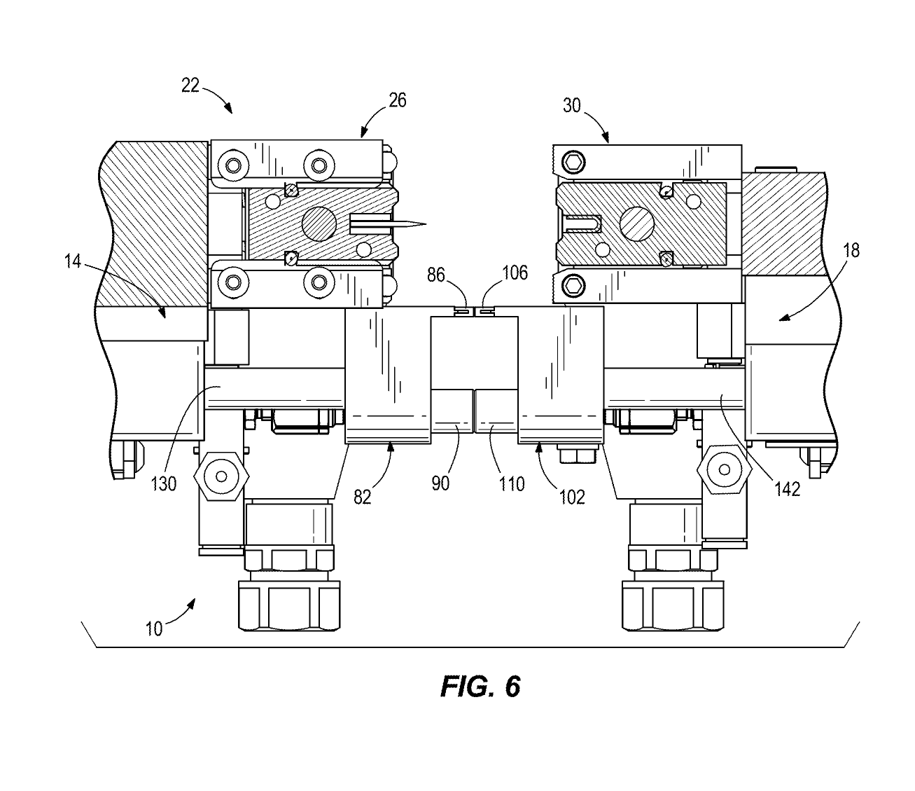

With reference to FIG. 6, once the first detector bar 82 and the second detector bar 102 have moved close enough to one another, the first stoppers 90 and the second stoppers 110 physically contact one another, and movement of the first detector bar 82 and the second detector bar 102 toward one another ceases. In some constructions, the first bumper 86 and the second bumper 106 remain at least slightly spaced apart from one another when the first stoppers 90 and the second stoppers 110 physically contact one another. During the movement of the first detector bar 82 and the second detector bar 102 toward one another, the first sealing jaw 26 and the second sealing jaw 30 also begin to move toward one another, such that when the first stoppers 90 and the second stoppers 110 contact one another, the first sealing jaw 26 and the second sealing jaw 30 have moved closer together, but are still separated by a gap.

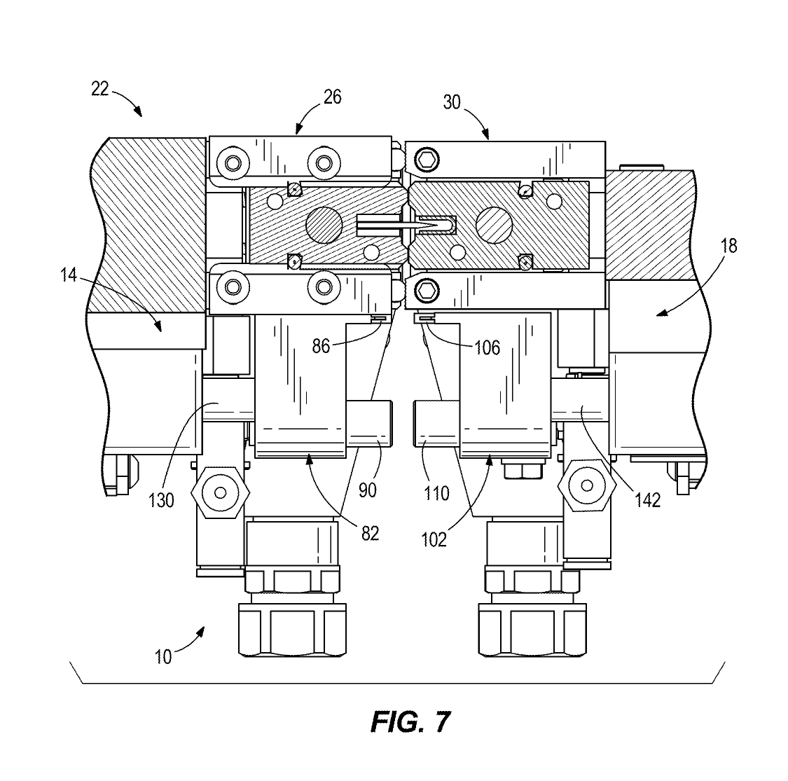

With reference to FIG. 7, once the first stoppers 90 and the second stoppers 110 have contacted one another, the first sealing jaw 26 and the second sealing jaw 30 continue to move toward one another, until a sealing operation occurs (e.g., sealing a top end of a bag or other packaging about the product). During this process, the first detector bar 82 and the second detector bar 102 begin to move linearly away from one another, due to activation (e.g., changing pressure within) the first linear actuator 122 and the second linear actuator 134. Once the sealing operation is complete, the first detector bar 82 and the second detector bar 102 return to the fully retracted positions illustrated in FIG. 4. Similarly, the first sealing jaw 26 and the second sealing jaw 30 also return to the fully retracted positions illustrated in FIG. 4.

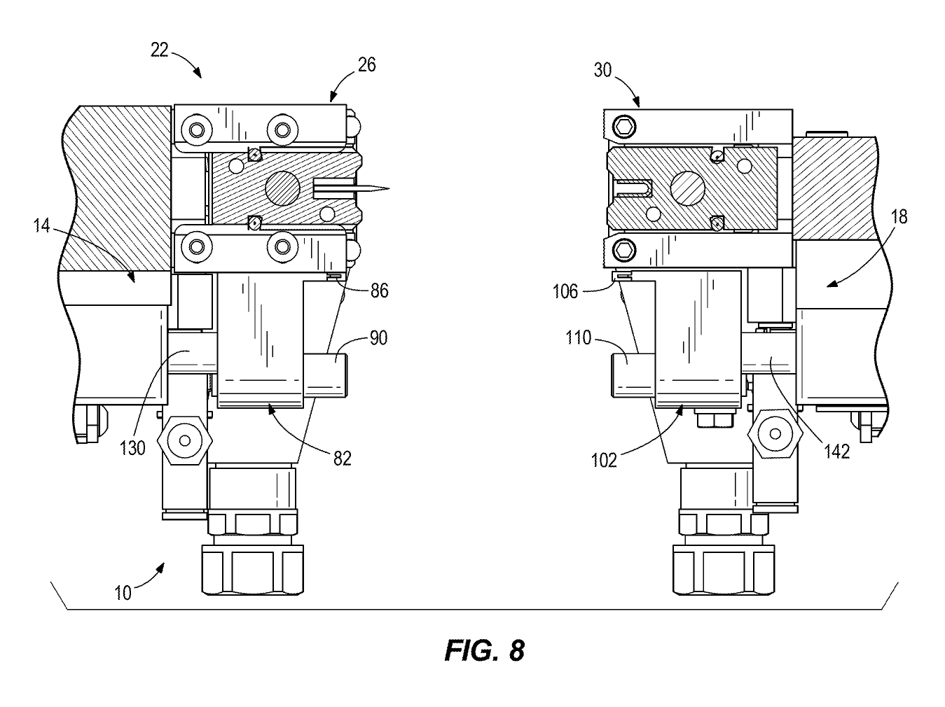

FIGS. 8-10 illustrate a sequence of operations of the product detection system 10 and the sealing machine 22, when a product is mis-aligned as it passes through the sealing machine 22.

With reference to FIG. 8, the first detector bar 82 and the second detector bar 102 are initially fully retracted away from one another. The first sealing jaw 26 and the second sealing jaw 30 are also initially fully retracted away from one another.

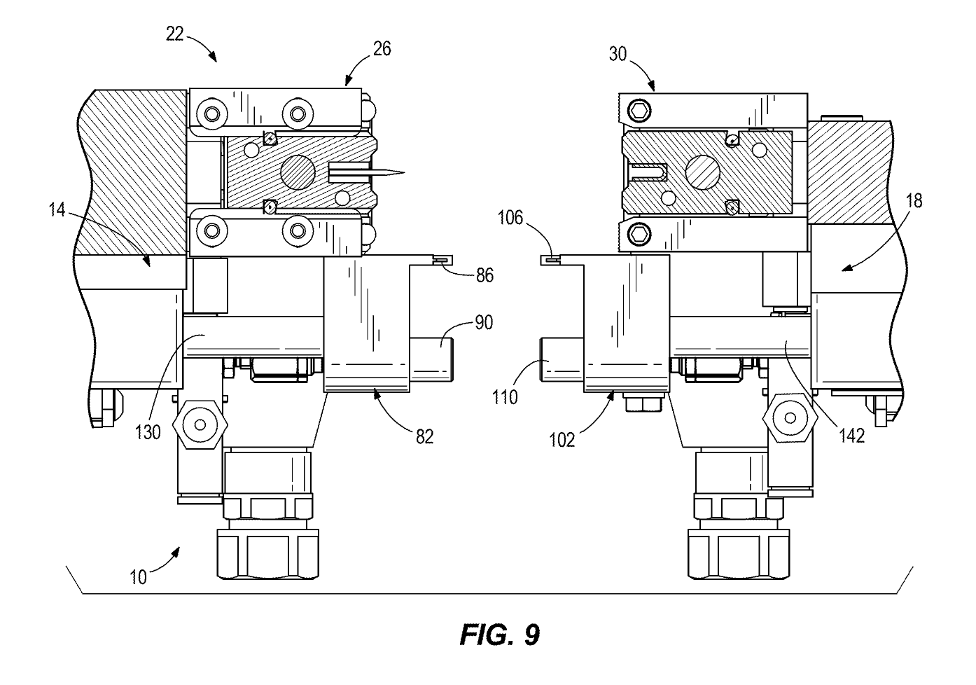

With reference to FIG. 9, the first sealing jaw 26 and the second sealing jaw 30 remain fully retracted away from one another while the first detector bar 82 and the second detector bar 102 begin to move toward one another, due to activation of (e.g., changing pressure within) the first linear actuator 122 and the second linear actuator 134.

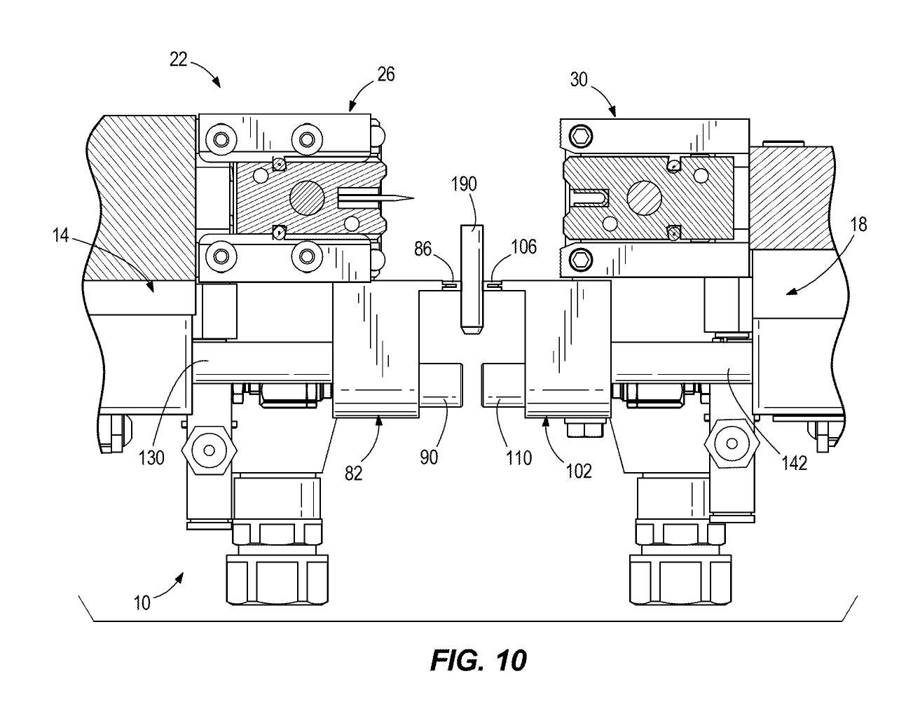

With reference to FIG. 10, if a product is misaligned, then a portion 190 of the product will extend beneath the sealing machine 22, and the first bumper 86 and the second bumper 106 will physically contact the portion 190 as the first detector bar 82 and the second detector bar 102 move toward one another. In the illustrated construction, the first bumper 86 and the second bumper 106 will physically contact the portion 190 at the same time, although in other constructions the timing may be different (e.g., in some constructions the second bumper 106 will first contact the portion 190, or the first bumper 86 will first contact the portion 190).

With continued reference to FIG. 10, the second linear actuator 134 exerts a lower force relative to the first linear actuator 122. For example, in the illustrated construction the second linear actuator 134 is stepped down in pressure from the first linear actuator 122, such that the second linear actuator 134 is more sensitive to detection of the portion 190 of the product with its second bumper 106 than the first linear actuator 122 is to detection of the portion 190 of the product with its first bumper 86. The difference in pressure between the first linear actuator 122 and the second linear actuator 134 causes the second bumper 106 and the second detector bar 102 overall to bounce back (i.e., reverse direction) upon physically contacting the portion 190 of the product. This bounce-back is felt by the linear encoder 158, due to the connection of the shaft 166 to the second detector bar 102. Thus, when the second bumper 106 physically contacts the portion 190 of the product, the second detector bar 102 bounces back, causing a displacement of the shaft 166 relative to the main housing 162, and informing the controller 186 of detection of a mis-aligned product. In constructions where the first linear actuator 122 and the second linear actuator 134 are servo driven linear actuators, the force in each linear actuator 122, 134 may be variable for example based on controls from the controller 186.

In some constructions, once the controller 186 determines that a mis-aligned product has been detected, the controller 186 stops the sealing machine 22, such that movement of the first sealing jaw 26 and the second sealing jaw 30 ceases. This prevents the product or products from being damaged, or the sealing machine 22 from being damaged. With the sealing machine 22 first stopped, the jaws 26, 30 then re-open so that the mis-aligned product may be removed. In some constructions, the first detector bar 82 and the second detector bar 102 fully retract (i.e., to the position illustrated in FIG. 8) once the mis-aligned product is detected.

The overall product detection system 10 thus acts as a live monitoring system to check for and detect mis-aligned products, and to safely shut down the sealing machine 22 in the event of a mis-aligned product. In the illustrated construction, the sealing jaws 26, 30 can close within about a 250 millisecond period, although other construction include different values and ranges. The live monitoring system can sense the bounce-back displacement of the second detector bar 102, via displacement observed by the linear encoder 158, and stop movement of the sealing jaws 26, 30 within about a 5-10 millisecond period to provide the rapid response needed for preventing damage to the product. In other constructions include different values and ranges of time for stopping movement of the sealing jaws 26, 30.

Various features and advantages of the invention are set forth in the following claims.

1. A product detection system comprising:
a first frame piece configured to be coupled to a first sealing jaw of a sealing machine;
a second frame piece configured to be coupled to a second sealing jaw of the sealing machine;
a first detector bar slidably coupled to the first frame piece;
a second detector bar slidably coupled to the second frame piece;
a first linear actuator coupled to the first detector bar to move the first detector bar;
a second linear actuator coupled to the second detector bar to move the second detector bar; and
an encoder coupled to the second detector bar to detect movement of the second detector bar;
wherein the first and second linear actuators are configured to move the first and second detector bars toward one another.

2. The product detection system of claim 1, further comprising a linear bearing coupled to the first frame piece and a slide rail that extends through the linear bearing, wherein the first detector bar is coupled to the slide rail.

3. The product detection system of claim 2, wherein the linear bearing is a first linear bearing and the slide rail is a first slide rail, the product detection system further comprising a second linear bearing coupled to the first frame piece and a second slide rail that extends through the second linear bearing, a third linear bearing coupled to the second frame piece and a third slide rail that extends through the third linear bearing, and a fourth linear bearing coupled to the second frame piece and a fourth slide rail that extends through the fourth linear bearing, wherein the second slide rail is coupled to the first detector bar, and wherein the third slide rail and the fourth slide rail are both coupled to the second detector bar.

4. The product detection system of claim 1, wherein the first detector bar includes a first bumper that extends from a first side of the first detector bar, and wherein the second detector bar includes a second bumper that extends from a first side of the second detector bar.

5. The product detection system of claim 4, wherein the first detector bar includes a first stopper that extends from the first side of the first detector bar, and wherein the second detector bar includes a second stopper that extends from the first side of the second detector bar.

6. The product detection system of claim 5, wherein the first side of the first detector bar faces the first side of the second detector bar, such that the first bumper is aligned with the second bumper, and the first stopper is aligned with the second stopper.

7. The product detection system of claim 1, wherein the first linear actuator and the second linear actuator are both air cylinders, and wherein the second linear actuator is stepped down in pressure from the first linear actuator.

8. The product detection system of claim 1, wherein the encoder is a linear encoder having a main housing and a shaft that is movable relative to the main housing, wherein the shaft is coupled to the second detector bar.

9. The product detection system of claim 8, wherein the second detector bar includes a slot, wherein an end of the shaft extends into the slot, and wherein a fastener extends into the slot to fasten the end of the shaft within the slot and fix the shaft to the second detector bar.

10. The product detection system of claim 8, wherein the main housing includes an aperture, wherein a cable is exposed through the aperture, and wherein the cable is configured to be coupled to a controller.

11. A system comprising:
a sealing machine having a first sealing jaw and a second sealing jaw, wherein the first and second sealing jaws are movable toward one another; and
a product detection system coupled to the sealing machine to detect a portion of a misaligned product, wherein the product detection system includes a first detector bar and a second detector bar that move toward one another and toward the portion of the misaligned product.

12. The system of claim 11, further comprising a linear encoder coupled to the second detector bar and a controller coupled to the linear encoder, wherein the linear encoder is configured to detect whether the first and second detector bars have contacted the portion of the product, and wherein the controller is configured to stop the sealing machine in response to the detection.

13. The system of claim 12, wherein the linear encoder includes a main housing and a shaft that is movable relative to the main housing, wherein the shaft is coupled to the second detector bar.

14. The system of claim 11, wherein the product detection system includes a first linear actuator coupled to the first detector bar and a second linear actuator coupled to the second detector bar, wherein the second linear actuator exerts a lower force relative to the first linear actuator, such that when the first and second detector bars contact the portion of the misaligned product, the second detector bar reverses direction and bounces back away from the portion of the misaligned product.

15. A method of detecting a portion of a misaligned product comprising:
directing a first detector bar and a second detector bar toward one another with a first linear actuator and a second linear actuator, respectively, wherein the second linear actuator exerts a lower force relative to the first linear actuator;
directing a first sealing jaw and a second sealing jaw toward one another;
contacting a portion of a misaligned product with the first and second detector bars;
reversing a direction of movement of the second detector bar upon contact of the portion of the misaligned product;
detecting the reversed movement of the second detector bar with a linear encoder; and
stopping movement of the first sealing jaw and the second sealing jaw toward one another upon detection of the reversed movement.

16. The method of claim 15, wherein the step of directing the first detector bar and the second detector bar toward one another occurs prior to the step of directing the first sealing jaw and the second sealing jaw toward one another.

17. The method of claim 15, wherein the step of contacting a portion of the misaligned product includes contacting the misaligned product with a first bumper on the first detector bar and a second bumper on the second detector bar.

18. The method of claim 15, wherein the linear encoder includes a main housing and a shaft that is movable relative to the main housing, and wherein the step of detecting the reversed movement includes detecting displacement of the shaft relative to the main housing.

19. The method of claim 15, wherein the linear encoder is coupled to a controller, and wherein the step of stopping movement of the first sealing jaw and the second sealing jaw is performed by the controller.

20. The method of claim 15, wherein the first detector bar is located below and adjacent the first sealing jaw, and wherein the second detector bar is located below and adjacent the second sealing jaw.
